(19) United States
(12) Patent Application Publication
(10) Pub. No.: US 2003/0035903 A1
(43) Pub. Date: Feb. 20, 2003

(54) Solventless thermosetting photosensitive via-filling ink

(76) Inventor: Syh-Tau Yeh, Ba-Der City (TW)

Correspondence Address: BACON & THOMAS, PLLC, 625 SLATERS LANE, FOURTH FLOOR, ALEXANDRIA, VA, 22314

(21) Appl. No.: 09/930,999

(22) Filed: Aug. 17, 2001

(51) Int. Cl. B05D 5/12; B05D 1/32; B05D 3/06

(52) U.S. Cl. 427/558; 427/282; 427/96

(57) ABSTRACT

The present invention relates to a solventless thermosetting photosensitive via-filling ink used in a hole-burying procedure in a printed circuit board (PCB) production process, and a method for filling a via using said via-filling ink. The solventless thermosetting photosensitive via-filling ink according to the present invention can be used to fill up the two ends of a via and form a rigid film by exposure to an ultraviolet light in order to protect the via-filling ink in the via from cross-linking, so that the via-filling ink will not flow out during a thermal baking process due to an insufficient viscosity of said ink. As a result, the via-filling ink thus formed has a smooth surface and a solid inside without void or hole formed therein.

### FIELD OF THE INVENTION

The present invention relates to a thermosetting photo-resist material used in the via-filling process for printed circuit board manufacturing.

### BACKGROUND OF THE INVENTION

In recent years, owing largely to the surging demands of mobile phones and notebook computers, consumers are increasingly demanding electronic products that are lighter, thinner, and smaller. The printed-circuit-board (PCB) industry, which has to support to the electronic industries in their development, are also pushed towards manufacturing processes that are capable of handling this trend. To make things lighter, thinner, and smaller, people generally resolve to pack more circuit density onto the ever-decreasing board area, or so-called high-density-integration. The technology of multi-layered boards manufacturing also plays an essential part to this evolution towards high-density-integration.

Particular to the multi-layered board manufacturing technology, sets of via have to be drilled to leave room for the formation of electronic connection between different layers. As it might sound absurd to some unknowing observers, these sets of via then have to be filled generally by some polymeric materials after the connections are made. The purpose of this is to protect the electronic connection within via. Without this via-filling material, the connector within via is subjected to oxidation from air trapped within. This could then lead to the problem of break of signal transmission, rendering the product involved useless. Therefore, the via-filling process, however minor it might seem, is a critical step in the multi-layered board manufacturing processes.

Though seemingly simple, via-filling isn't without complications and can be a troublesome step sometimes. Common problems encountered are such as bubbles inside the filling, volcanoes on the surface, recessed or bulged filling surface profiles along the plane of circuit patterns. At present, the industry-wise yield-rate of this step is still far from satisfactory. A key factor for resolving this issue, of course, lies in the filling material itself. If improvements can be made to the composition of the filling material so that it does not expand or contract much during the subsequent curing step, then there should not be much of surface bulge or recess. Also, if solvent can be removed from the filling composition, then there shouldn't be too much problem of volcanoes and bubbles, which generally happens because of solvent evaporation. Good via-fillings can be achieved utilizing the abovementioned concepts. FIG. 1 shows a schematic diagram of a via structure formed in a conventional printed circuit board manufacturing process, wherein the via structure comprises: a substrate 10; a via 20 formed by a through hole on said substrate 10; a circuit pattern layer 30 formed on said substrate 10 by forming a copper ring on the via wall of said substrate 10.

A good via-filling is illustrated in FIG. 2, where the filling is solid and void-free after cross-linking of the via-filling material 40. Furthermore, the surface on both ends of the cylinder formed within the surrounding copper ring 21 has to be smooth 41 so as not to cause a problem in the subsequent manufacturing process. In real life, however, this sometimes is difficult to achieve. One typical problem is the recess on the filling surface, which is illustrated in FIG. 3, where a recess 42 is found on the via-filling material 40 after cross-linking.

At present, commercially available via-filling materials contain both solvent and solvent-less types. In some printed circuit board manufacturing processes with less stringent requirements, people have used solder resist material for via filling. Since the solvent content for most commercial solder resist products is relatively high, i.e. up to 25%, this tends to create problems of voids or recessed surfaces. These problems occur because of solvent evaporation in the subsequent baking process. The via-filling material therefore shrinks to compensate for the loss of the volume of solvent, thus creating problems of recessed surfaces or voids. This explains the detrimental effects of solvent.

Therefore, to fully resolve problems occurring at the ensuing curing step, a solvent-less product is a must. Current market preference of the solvent-less products over the solvent ones is a proof of this concept. Unfortunately, current commercial via-filling products still present certain problems, thus the yield rate is largely limited. Sagging is a commonly problem commonly cited, which is the flowing of the filling material out of via during the curing process. This is caused by viscosity changes. The viscosity of the uncured filling material 40 tends to be low the curing temperature (e.g. 150° C.), presenting little resistance to the flow of filling material. The filling material thus tends to flow out of via along the vertically mounted PCB 10 under the influence of the gravity, as shown in FIG. 4. This results in the lack of coverage by the filling material along the top edges of via, and excessive coverage by the material along the bottom edge of via.

### SUMMARY OF THE INVENTION

Regarding the abovementioned problems, the objective of the present invention is to provide a solvent-less thermosetting via-filling product that is also photosensitive. Combining these two properties yields a product that gives good performance for the via-filling requirements. This solvent-less thermosetting photosensitive via-filling material according to the present invention comprises:

one or more liquid epoxy resins;

one or more cationic photo initiators;

one or more cationic epoxy resin thermal curing agents;

one or more optional inorganic fillers for adjusting physical properties thereof such as electrical insulation, acid resistance, rheological properties, etc.; and

one or more optional organic adjuvants for achieving desired processing characteristics for the via-filling step.

Another objective of the present invention is to provide a method of using a solvent-less thermosetting photosensitive material for filling via, which comprises:

providing a PCB with a via to be filled up;

coating of a solvent-less thermosetting photosensitive material for filling up said via;

exposing the via-filling material to UV light to form solid barrier films at both ends to prevent the liquid material from flowing out of via during the thermal curing process; and

baking to cure the filling material in via.

### BRIEF DESCRIPTION OF THE DRAWINGS

FIG. 1 shows a schematic diagram of a via structure formed by a through hole in a conventional PCB;

FIG. 2 shows a schematic diagram of a via-filling material after curing;

FIG. 3 shows a schematic diagram of a recess on the via-filling material surface;

FIG. 4 shows a schematic diagram, illustrating the problem of sagging caused by the lowering of viscosity of the filling material at curing temperature. It shows that the top edge lacks in coverage of filling material, while the lower edge is excessively covered with filling material;

FIG. 5(A)-5(C) show schematic diagrams of examples for filling up a via with a solvent-less thermosetting photosensitive material according to the present invention;

FIG. 6 shows a schematic diagram of filling up a via with a solventless thermosetting photosensitive material according to the present invention;

FIG. 7 shows molecular structures of cationic photo-initiators of Mixed Triarylsulfonium Hexafluoroantimonate Salts; and

FIG. 8 shows molecular structure of cationic photo-initiators of Mixed Triarylsulfonium Hexafluorophosphate Salts.

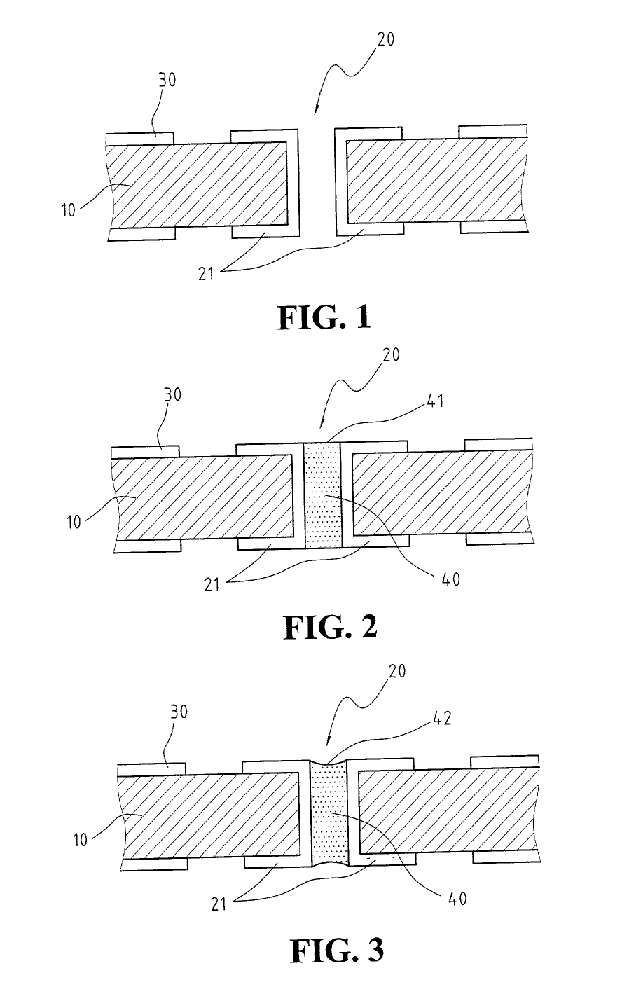

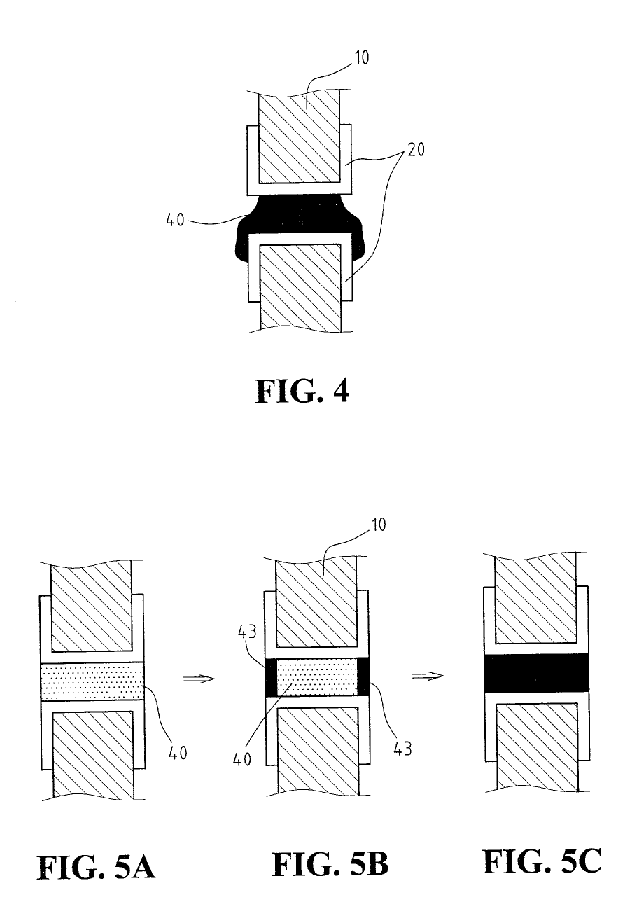

### DETAILED DESCRIPTION OF THE INVENTION

A solvent-less thermosetting photosensitive via-filling material according to the present invention, based on 100 parts of the epoxy resin, comprises:

one or more liquid or non-liquid epoxy resins including Bisphenol-A, Bisphenol-F, Phenol Novolac, Cresol Novolac and other hetero epoxy resins, the amount of the epoxy resins being determined by the actual need and being referred as 100 parts for calculating the ratio of other compositions;

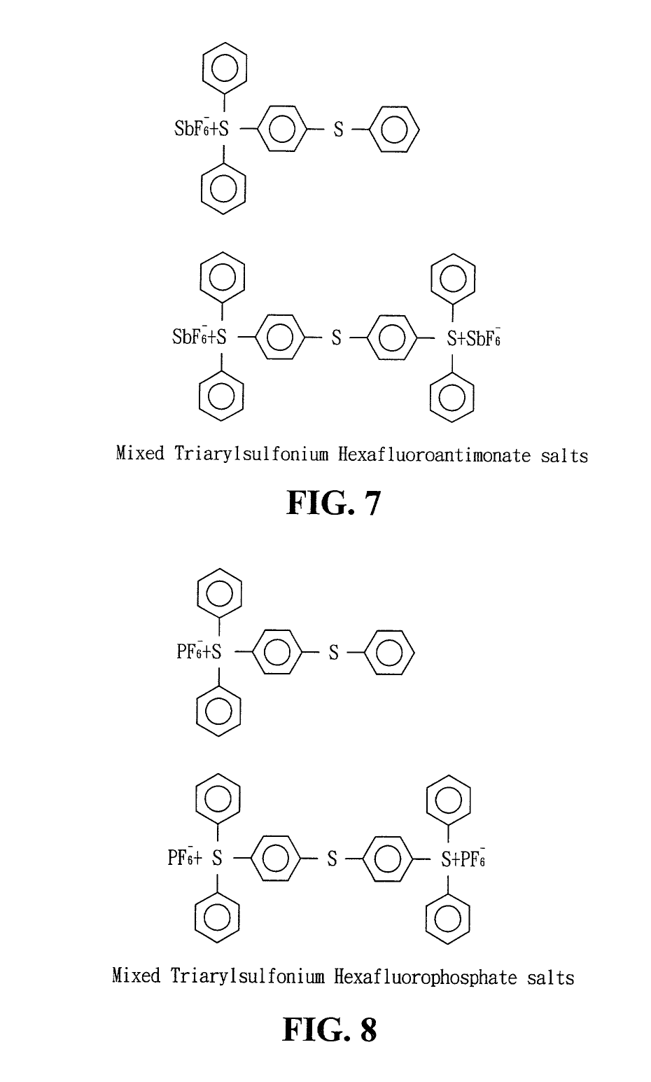

one or more cationic photo initiators including: Onium salts, Mixed Triarylsulfonium Hexafluoroantimonate Salts, or Mixed Triarylsulfonium Hexafluorophosphate Salts, the molecular structures thereof being shown in FIG. 7 and FIG. 8, with an amount of 0.5˜20 parts based on 100 parts of said epoxy resins;

one or more cationic epoxy resin thermal curing agents including: Phenol-Formaldehyde resins, Urea-Formaldehyde resins, Anhydride, and Melamine-Formaldehyde resins, with an amount of 5˜100 parts based on 100 parts of said epoxy resins;

optionally a cationic thermal catalyst for reducing the baking time, with the amount of 0˜5.0 parts based on 100 parts of said epoxy resins;

optionally one or more inorganic fillers, such as silicon dioxide, barium sulfate, talcum powder, etc., for adjusting the physical properties thereof such as electrical insulation, acid resistance, rheological properties, etc., with an amount of 0˜200 parts based on 100 parts of said epoxy resins; and

optionally one or more organic adjuvants for achieving desired processing characteristics of the via-filling ink, which can be a de-foaming agent, a leveling agent, a theological adjuvant, or a dye, etc., with an amount of about 0˜50 parts based on 100 parts of said epoxy resins.

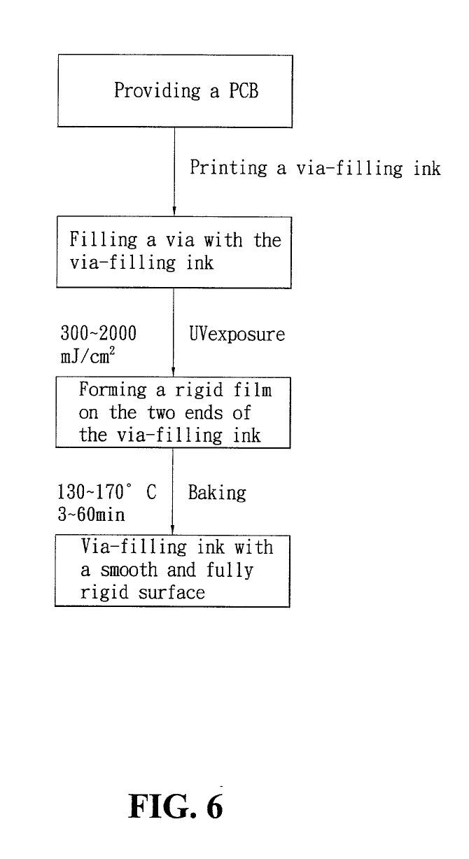

As shown in FIG. 6, according to the present invention, an example of a method of using a solvent-less thermosetting photosensitive material for filling a via, comprises:

providing a PCB with a via to be filled up;

coating of a solvent-less thermosetting photosensitive material for filling up said via;

exposing the filling material to UV to form barrier films at both ends of the via-filling material to prevent the liquid filling material from flowing out of via during the thermal curing process; and thermally cure the via-filling material in via.

According to the present invention, said solvent-less thermosetting photosensitive material 40 could fill up said via 20 by screen printing on a PCB 10, as shown in FIG. 5(A). Then, said PCB 10 was mounted in a 7 kW ultraviolet exposure machine for an exposure energy of 300˜2000 mJ/cm², forming solid barrier films with a thickness of greater than 50 μ (about ⅕ the thickness of the PCB), as shown in FIG. 5(B). The exposure energy should be high enough so that the integrity of the solid barrier film is not comprised but not so high as to cause scorching of the solid barrier films. Experiments carried out by this inventor indicate that an the optimum exposure energy is in the range of 300˜2000 mJ/cm² for said ultraviolet exposure machine.

After ultraviolet exposure, a thermal curing process is subsequently carried out at a temperature of 100˜260° C. for at least 1 minute. The via-filling material 40, after thermal curing, should be cylindrical in shape with flat surface profiles and solid interior containing no voids or holes, as shown in FIG. 5(C). This process has the potential of significantly increasing the production yield rate for the via-filling process.

Thus. the solvent-less thermosetting photosensitive via-filling material according to the present invention can achieve the expected objectives and effects, and meet the novelty, inventive steps and industrial application requirements for a patent.

However, the abovementioned drawings and explanations are preferred examples of the present invention only, and are not for limiting the scope of the present invention. A person skilled in the art can modify or change the present invention without departure from the scope thereof, which is stipulated in the following claims.

What is claimed is:

1. A solventless thermosetting photosensitive via-filling material, which comprises:
one or more liquid epoxy resins or blends of solid and liquid epoxy resins;
one or more cationic photo-initiators;
one or more thermal cationic curing agents;
one or more optional inorganic fillers for adjusting the physical properties thereof such as electrical insulation, acid resistance, rheological properties, etc.; and
one or more optional organic adjuvants for achieving desired processing characteristics of said via-filling material.

2. The solvent-less thermosetting photo-sensitive via-filling material as claimed in claim 1, in which said epoxy resins at least include: Bisphenol-A, Bisphenol-F, Phenol Novolac, Cresol Novolac and other hetero epoxy resins, the amount of the epoxy resins being, determined by the actual need and being referred as 100 parts for calculating the ratio of other compositions.

3. The solvent-less thermosetting photo-sensitive via-filling material as claimed in claim 1, in which the cationic photo-initiator at least includes: Onium salts, Mixed Triarylsulfonium Hexafuoroantimonate Salts, or Mixed Triarylsulfonium Hexafluorophosphate Salts, with an amount of 0.5˜20 parts based on 100 parts of said epoxy resins.

4. The solvent-less thermosetting photosensitive material as claimed in claim 1, in which said thermal cationic curing agents at least includes: Phenol-Formaldehyde resins, Urea-Formaldehyde resins, Anhydride, and Melamine-Formaldehyde resins, with an amount of 5˜100 parts based on 100 parts of said epoxy resins.

5. The solvent-less thermosetting photosensitive material as claimed in claim 1, in which a thermal cationic catalyst can be optionally added for increasing the curing speed, with an amount of 0˜5.0 parts based on 100 parts of said epoxy resins.

6. The solvent-less thermosetting photo-sensitive material as claimed in claim 1, in which said inorganic fillers are silicon dioxide, barium sulfate, or talcum powder, with an amount of 0˜200 parts based on 100 parts of said epoxy resins.

7. The solvent-less thermosetting photosensitive material as claimed in claim 1, in which said organic adjuvants is a de-foaming agent, a leveling agent, a rheological adjuvant, or a dye, etc., with individual amount of about 0˜50 parts based on 100 parts of said epoxy resins.

8. A method of using a solvent-less thermosetting photosensitive material or filling a via, which comprises:
providing a PCB with a via to be filled up;
poating of a solvent-less thermosetting photosensitive material to fill up said via;
exposing the filling material to UV to form a solid barrier film at both ends; and
thermally cure the filling material in via.

9. The method of using a solvent-less thermosetting photosensitive material for via-filling as claimed in claim 8, wherein the said filling material is squeezed into via by a screen-printing process.

10. The method of using such a solvent-less thermosetting photo-sensitive material for via-filling as claimed in claim 8, wherein the UV exposure energy is optimally in the range of 300˜2000 mJ/cm².

11. The method of using such a solvent-less thermosetting photosensitive material for via-filling as claimed in claim 8, wherein the thermal curing temperature is preferably 100˜260° C., with curing time of no less than 2 minutes.
